(19) United States
(12) Patent Application Publication
(10) Pub. No.: US 2004/0181890 A1
(43) Pub. Date: Sep. 23, 2004

(54) Dual action sweeper

(76) Inventor: Orin A. Roberson, Houston, TX (US)

Correspondence Address: Darcell Walker, Suite 250, 9301 Southwest Freeway, Houston, TX, 77074, US

(21) Appl. No.: 10/805,789

(22) Filed: Mar. 22, 2004

Related U.S. Application Data
(60) Provisional application No. 60/456,505, filed on Mar. 21, 2003.

(51) Int. Cl. A46B 5/00; B25G 3/38

(52) U.S. Cl. 15/144.1

(57) ABSTRACT

The present invention is a dual action sweeper (‘DAS’) that comprises a dust mop section with a “regular broom” attached to either edge of the dust mop section. The broom section is retractable to allow users to get close to walls during use of the dust mop section. The DAS allows the user to switch between the dust mop function and the regular broom function with relative ease and speed. This flexibility allows the user to efficiently clean and continue working regardless of changes in the type of surface, which the user is cleaning. With the press of a button on the handle, the unit adjusts and locks to the sweeping mechanism that's best for the surface at hand. The handle of the DAS automatically adjusts to the length necessary for the user to efficiently use either feature.

### CROSS REFERENCE TO RELATED APPLICATION

This application claims priority from provisional patent application No. 60/456,505, filed on Mar. 21, 2003, the contents of which are hereby incorporated by reference.

### FIELD OF THE INVENTION

The present invention is an apparatus for cleaning various types of surfaces and more particularly to an apparatus that performs the dual operations of sweeping and dust mopping a cleaning surface.

### BACKGROUND OF THE INVENTION

Numerous brooms have been invented and used over the years. Generally, they all allow the use to stand upright while sweeping the floor surface. At the bottom of a long handle is generally found a plurality of cleaning bristles with one end of the bristles attached to the end of the handle and the other end of the bristles contacting the floor. The broom is moved in an arc in a sweeping motion with the loose end of the bristles contacting the floor in order to sweep dust and dirt from the floor surface. Different types of handles and bristles have been used in the past but none of the devices employ a mechanism to clean the dust and dirt entrapped between the bristles. This results in a build-up of dust and dirt between the broom's bristles. This effects the efficiency of the broom. In the past, in order to clean the bristles, the broom was shaken or the user would place his or her hand between the bristles in order to pull out the dust and entrapped dirt.

The conventional dust mop is designed with pockets on the upper side, and yarns on the lower side. The pockets receive the frame, and generally include a fastening means such as ties, snaps or the like, to hold the frame within the pockets. Most of the prior art mop heads have had pockets that have one opening to allow the frame to be received within the pocket, and the pocket then secured; however, U.S. Pat. No. 5,165,136 discloses a mop head designed to fit a mop frame having a bumper thereon, so the pockets are more open than usual. After receiving the mop frame, the pockets are closed by snaps or the like to hold the mop head on the frame. A major difficulty with the pockets of the prior art is that the mop head is produced in a plurality of different steps, requiring multiple handlings of several pattern pieces. The production system is therefore very inefficient.

With reference to a dust mop, there are several techniques for applying yarn to a mop head, and many of these are quite efficient in themselves. The problem is, again, the fact that each piece of the mop head must be handled several times. Also, the yarn is attached to one piece of fabric, which may be a fiber-filled polypropylene sheet, and additional pieces of fabric are sewn to the one piece of fabric to complete the mop head. A final step for a prior art mop head may therefore be to sew three or more layers of fabric together. This is of course a difficult task that is usually performed by a person, which both limits the output and increases the cost.

Thus, the prior art provides a mop frame, and a mop head receivable over the frame. The mop head has closable pockets to receive the mop frame therein, so the mop head is fixed around the frame. One prior art mop frame comprises a flat member of polymeric material, and a mop head is attached to the mop frame by hook and loop fasteners such as “Velcro” fasteners.

In many houses, there are floors that comprise multiple surfaces connected together. In one example, there can be a tile floor section with carpet squares all around the tile floor section. In conventional cleaning, this type of surface will require the cleaner to use a dust mop on the tile section and then switch to another apparatus to clean the carpet. The reason for this requirement is because the dust mop will not efficiently and effectively clean the carpet. As a result, the cleaner typically has to locate and use a second cleaning apparatus on the same floor. There remains a need for an apparatus that can combine the features of both the broom and mop into one device that can provide versatility and flexibility when cleaning surfaces using a mop or broom device.

### SUMMARY OF THE INVENTION

It is an objective of the present invention to provide an apparatus that will allow efficient sweeping operations in environments that have varying types of surfaces such as tile, carpet, cement and wood.

It is second objective of the present invention to provide a dual action sweeper apparatus that can be used to efficiently perform any sweeping operation

It is a third objective of the present invention to provide an apparatus that can be used to efficiently clean surfaces such as tile, carpet and various material surfaces such as cloth.

The present invention is a dual action sweeper (‘DAS’) that comprises a dust mop section with a “regular broom” attached to either edge of the dust mop section. The broom section is retractable to allow users to get close to walls during use of the dust mop section. The DAS allows the user to switch between the dust mop function and the regular broom function with relative ease and speed. This flexibility allows the user to efficiently clean and continue working regardless of changes in the type of surface, which the user is cleaning. With the press of a button on the handle, the unit adjusts and locks to the sweeping mechanism that's best for the surface at hand. The handle of the DAS automatically adjusts to the length necessary for the user to efficiently use either feature. The unit has a unique alignment mechanism to allow for ease and efficient guidance of the locking mechanism.

### DESCRIPTION OF THE DRAWINGS

FIG. 1 is a top and side view of the cleaning apparatus of the present invention.

FIG. 2 is a bottom and side view of the cleaning apparatus of the present invention.

FIG. 3 is an exploded view of the cleaning apparatus of the present invention.

FIG. 4 is side view of the cleaning apparatus of the present invention.

FIG. 5 is a front view of the cleaning apparatus of the present invention.

FIG. 6 is a view of the rotary joint of the present invention.

### DETAILED DESCRIPTION OF THE INVENTION

The present invention is a dual action sweeper (‘DAS’) that comprises a dust mop section with a “regular broom” attached to either edge of the dust mop section. The broom section is retractable to allow users to get close to walls during use of the dust mop section. The DAS allows the user to switch between the dust mop function and the regular broom function with relative ease and speed.

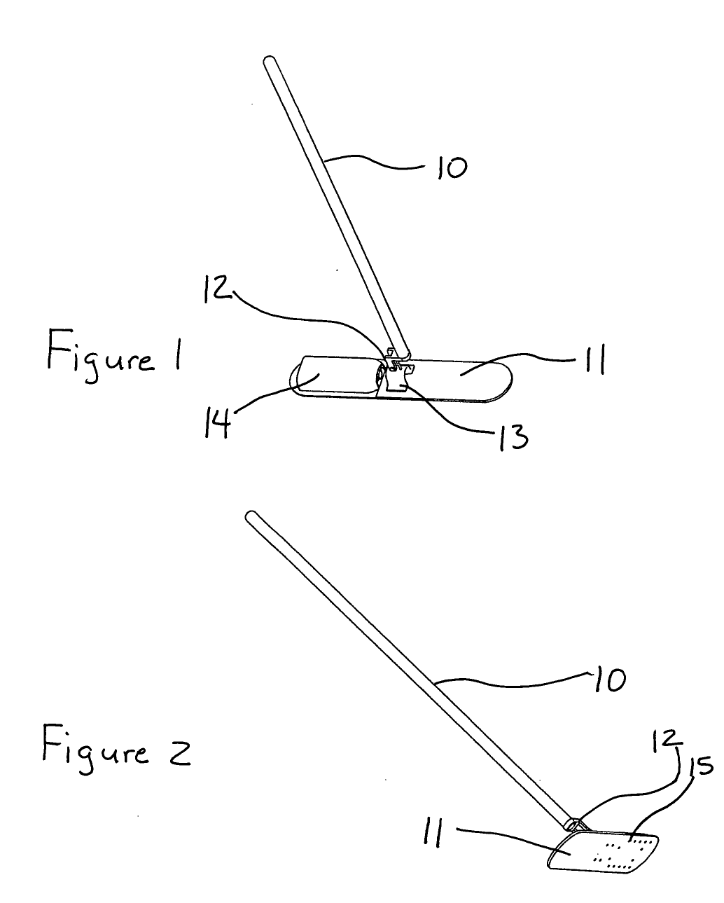

Referring to FIG. 1, shown are the main components of the present invention. The invention comprises an adjustable handle 10 that is attached to the frame assembly 11, which serves as the base of the device. The handle comprises internal and external tubes. The handle can also have an actuating means that will enable the user to move one tube of the handle with reference to the other tube. A bracket 12 attaches the handle to the base 11. A base hold component 13 attaches to the base and to the bracket 12 to facilitate the attachment of the handle to the base. The hold component has an arc shape with an opening between the base 11. This opening provides a clearance and path for the handle element 10 when the invention is in the sweeping position. Also shown is a cover 14 that covers and protects a broom device which part of the present invention. FIG. 2 shows the bottom side of the present invention. The base 11 contains holes 15 used to attach a cleaning component to the base. This cleaning component can be a mop type component or bristles for cleaning a floor surface.

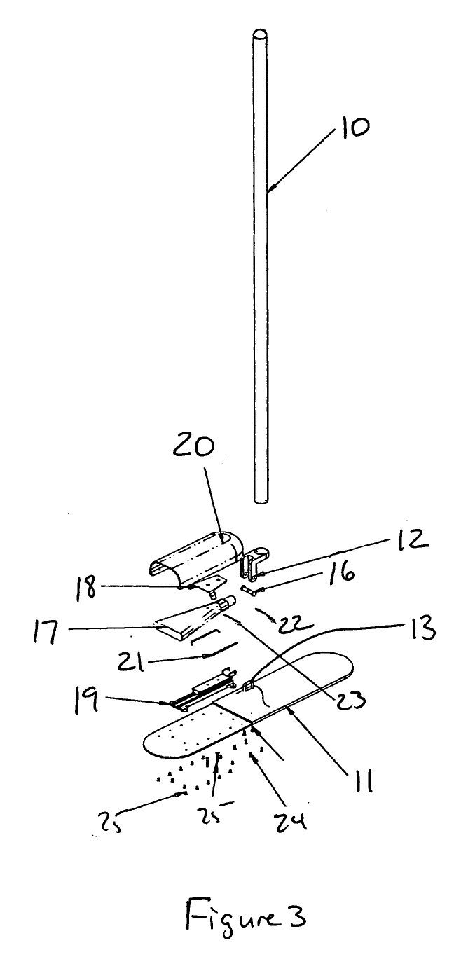

Referring to FIG. 3, shown is an exploded view of the present invention. The handle 10 fits into the joint rotary bracket 12 through an opening in the bracket. The bracket 12 is in two sections (see FIG. 6). These two sections form an L-shape. Section 12a has an opening that receives the handle 10. Section 12b extends downward and connects to the base hold component 13 which attached to the base 11. A sugino seat bolt 16 connects the hold component to the joint rotary bracket and facilitates the attachment of the hold component to the bracket.

The base 11 has one portion that comprises a sweeping element 17 that is attached to the base. This sweeping element can be a broom or other sweeping device. The sweeping element 17 rests on the base 11 and is attached to the base via a broom hold component 18 and a rail assembly 19. This rail assembly can have various designs. An alternate design is one having matching rail or wall guides that guide the sweeping elements along a define path. A cover 20 fits over the sweeping element to provide an ecstatic appearance of the invention. Bungie cords 21 are attached to the sweeping element and provide elastic force the assist in moving the sweeping element from one position to another during the process of changing the position of the invention. Pins 22 and 23 attach the sweeping element 17 to the broom hold component 18. In addition, screws 24 and 25 attach the cleaning elements to the base.

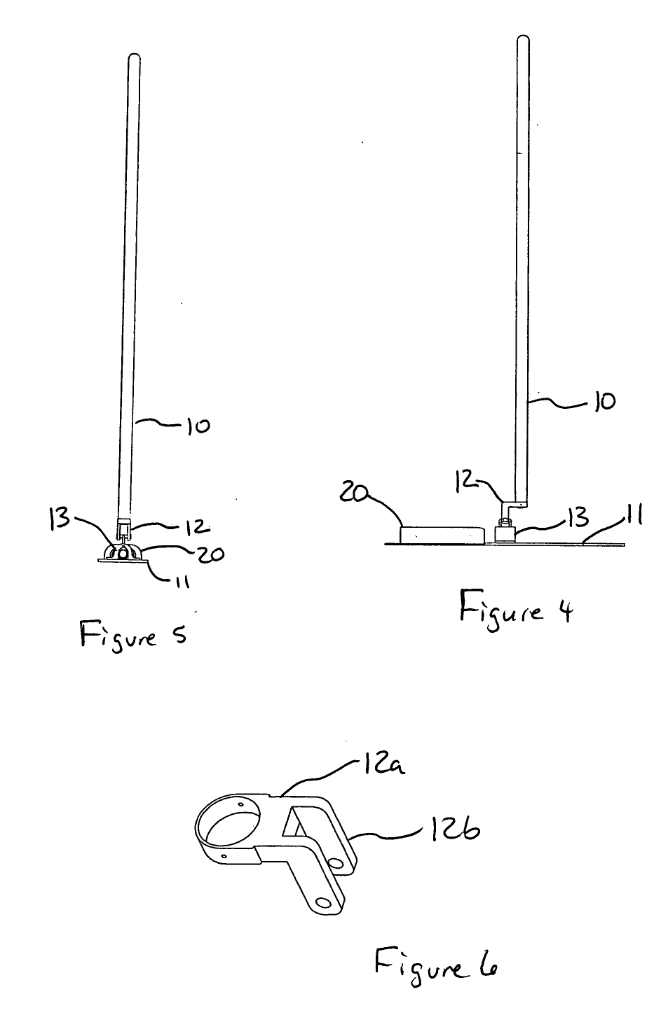

FIG. 4 shows a side view of the present invention when the apparatus is in the standard position. As shown, the handle 10 extends down through the rotary joint bracket 12, which is connected, to the base 11 via the base hold component 13. Also shown is the sweeping element cover 20 and sweeping element that rests on the base. FIG. 5 shows a front view of the present invention when the apparatus of the present invention is in the standard cleaning position. In this shown is the shape of the base hold component 13 attached to the joint rotary bracket 12.

As previously mentioned, FIG. 6 shows the rotary joint bracket 12. This bracket has two sections, which join to form an L-shape. Section 12a has an opening that receives the handle 10. Section 12b attaches to the bracket to the base hold component 13 to form the hinge component of the device. This hinge component facilitates the converting of the device of the present between the two different cleaning positions.

As mentioned, the present invention has two operating positions. The standard position, which is illustrated in the figures, and a sweeping position. In the sweeping position, the base will be in a parallel position to the handle. This parallel position of the base will expose the sweeping element and enable the sweeping element to be in contact with the surface that the user desires to sweep. During the process of cleaning a surface, the user will usually have the device in a standard position. If the user desires to convert the device to the sweeping position, the user will lift the device in the air via the handle. The base is attached to the handle via the joint rotary bracket and the hold component. As mentioned, the joint rotary bracket and hold component form as hinge as shown in FIG. 4. Because of the sweeping element and guide means on one side of the base, the weight on the base is not balanced. As a result, when the device is lifted into the air, the weight on one side of the base will cause the base to rotate to a position parallel with the handle. When the base is rotated, the opening in the hold component will align with the opening in the joint rotary bracket and form a path through which the inner tube of the handle can extend. The extending of the inner tube through the openings provides a means to lock the base in the position parallel to the handle while in the sweeping position. A groove in the external handle and an extension knob attached to the inner tube can provide a means through which the user can extend the inner tube of the handle. After the base is in this new position, the bungee cords can be used to adjust the sweeping element for use in a sweeping action for cleaning the desired surface. When the user has finished the sweeping action, the device can remain in the sweeping position or can be converted back to the standard position by readjusting the inner tube of the handle.

The device of this invention provides significant advantages over the current art. The invention has been described in connection with its preferred embodiments. However, it is not limited thereto. Changes, variations and modifications to the basic design may be made without departing from the inventive concepts in this invention. In addition, these changes, variations and modifications would be obvious to those skilled in the art having the benefit of the foregoing teachings. All such changes, variations and modifications are intended to be within the scope of this invention.

I claim:

1. A dual position-cleaning device that provides the ability to clean a surface using a sweeping motion when to device is in one position and a pushing motion when the device is in the other position comprising:
a handle;
a base connected to said handle, the base having flat top and bottom surfaces, the bottom surface having a cleaning element attached thereto to be in contact with a surface to be cleaned with the device when using a pushing motion;
a sweeping element positioned on the top side of the base, said sweeping element to be in contact with a surface to be cleaned with the device when using a sweeping motion;
a hinge component that attaches the base to the handle and facilitates the converting of the device from one position to the other position as desired; and
a guide mechanism that facilitates the movement of the sweeping element during the converting of the device from one position to the other position.

2. The dual position-cleaning device as described in claim 1 wherein the hinge component further comprises a joint rotary bracket and a hold component.

3. The dual position-cleaning device as described in claim 2 further comprising a cover over the sweeping element.

4. The dual position-cleaning device as described in claim 1 wherein said handle further comprises an internal tube and an external tube, said internal tube capable of movement relative to the position of said external tube.

5. The dual position-cleaning device as described in claim 1 wherein said handle further comprises an internal tube and an external tube, said external tube capable of movement relative to the position of said internal tube.

6. The dual position-cleaning device as described in claim 4 wherein said handle further comprises a groove in said external tube extending in defined length along a side of said external tube and a knob attached to said internal, said knob extending through the groove in said external tube to provide a means to move said internal tube relative to said external tube.

7. The dual position-cleaning device as described in claim 1 further comprising an elastic means attached to said sweeping element to facilitate the movement of said sweeping element during the converting of the cleaning device between positions.

8. The dual position-cleaning device as described in claim 2 wherein said rotary joint bracket further comprises a first section for receiving the handle and a second section for engaging the hold component, said first and second sections of said rotary joint bracket forming an L-shape.

9. The dual position-cleaning device as described in claim 2 wherein said hold component has a U-shape which forms a channel through which said handle can extend.
